(19) United States
(12) Patent Application Publication
(10) Pub. No.: US 2004/0210491 A1
(43) Pub. Date: Oct. 21, 2004

(54) Method for ranking user preferences

(76) Inventor: Pasha Sadri, San Jose, CA (US)

Correspondence Address: COUDERT BROTHERS LLP, 333 SOUTH HOPE STREET, 23RD FLOOR, LOS ANGELES, CA, 90071, US

(21) Appl. No.: 10/626,151

(22) Filed: Jul. 24, 2003

Related U.S. Application Data
(60) Provisional application No. 60/463,745, filed on Apr. 16, 2003.

(51) Int. Cl. G06F 17/60

(52) U.S. Cl. 705/26

(57) ABSTRACT

The present invention is a method for ranking user preferences. The searched item is categorized in classes, and the sort mechanism gives the user a list of attributes of the item. The user can pick one or more attributes of the item from a list, or the user can edit the list of attributes. Each attribute is given a value, which is used to display the results of the search in real time. The value of each attribute may not exceed a certain threshold, and if it does, the search mechanism normalizes accordingly. The results can be further sorted in real time by either changing the value of one or more attributes, or by clicking on a heading of an attribute thus making it the most (or least) important attribute from the list of attributes.

### CROSS-REFERENCE TO RELATED APPLICATIONS

The present application claims the benefit of priority from pending U.S. Provisional Patent Application No. 60/463,745, entitled “A Method For Ranking User Preferences”, filed on Apr. 16, 2003, which is herein incorporated by reference in its entirety.

### BACKGROUND OF THE INVENTION

1. Field of the Invention

The present invention relates to the field of a method for ranking user preferences.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

When shopping for items, especially on the Internet, a user is often confronted with a number of choices. For example, when shopping for digital cameras, a list of available cameras may be presented to the user. In some cases, it may be possible to sort the list, using such factors as price, memory size, features, etc. For example, when a customer is in the market to buy a digital camera, and is not sure of which model, the user wants to know the different types of digital cameras available in the price range, pixel amount, or any other features of the digital camera that are important to the user. Many times the user may want to trade off one attribute with another, or simply change the criteria of one or more attributes. For example, a user may start with a price range of “under $500” for a digital camera as the most important attribute of the camera along with “at least 4.0 mega pixels” and “under 5 oz. in weight”, and may find a limited list.

Prior art search engines to search and sort data do not provide adequate ranking and sorting of selections because the search criteria is interpreted too exactly, there is no way of considering a combination of factors, and there is no easy way to explore different tradeoffs.

### SUMMARY OF THE INVENTION

The embodiments of the present invention provide a method to rank items according to one or more user attributes or criteria, and to display the items to the user based on the input class of the item. According to one embodiment, the user is given a list of attributes of the input class that the search mechanism assumes to be important to the user. According to another embodiment, the user is given a list of attributes of the input class of the item from which the user can choose one or more attributes important to the user. According to another embodiment, there is a user interface section that allows the user to input one or more attributes of the class not mentioned in the list. According to another embodiment, the user picks the level of importance (value) of each of the attributes, such that the sum of the levels of importance of all the attributes (total or overall value) does not exceed a maximum threshold (maximum or perfect value).

According to another embodiment, the level of importance of each chosen attribute is a user interface component. This component may be a slider within a sliding bar that can be shifted from the leftmost position (position of least importance) to any position up to the rightmost position (position of most importance), a series of radio buttons with titles such as “least important”, “slightly important”, “important”, and “very important”, or maybe some other yardstick that is easily understood by the user. According to one embodiment, the search mechanism has a maximum threshold set on one or more attributes. When the maximum threshold on these attributes is reached, they change when the level of importance of other attributes are inputted by the user so that the values of all the attributes does not exceed the total maximum threshold.

According to another embodiment, the results of the search are displayed to the user in real time, a feature that can be turned on if the user feels that the class being searched is one whose attributes change constantly. If the user turns on the real time feature, it means that if the value of certain attributes such as price of a stock or availability of a camera changes while the user is still using the search mechanism, the values are refreshed in real time based on the most current attribute value. It also means that if the user changes (sorts) the level of importance of one or more attributes, the results refresh based on the most current attribute value. According to another embodiment, the results are displayed in a tabular format with the item in the first row of the table being the one that has a highest total threshold, and the last item has the least total threshold. According to another embodiment, the table has column headings corresponding to the attributes. The result of the search can be sorted using a form of user interface such as clicking on a heading thus changing the order of the result.

### BRIEF DESCRIPTION OF THE DRAWINGS

These and other features, aspects and advantages of the present invention will become better understood with regard to the following description, appended claims and accompanying drawings where:

FIG. 1 is a flowchart that gives a list of attributes of an item that the sort mechanism assumes to be important to the user, according to one embodiment of the present invention.

FIG. 2 is a flowchart that gives a list of attributes that the sort mechanism assumes to be important to the user who can then choose one or more attributes from the list, according to one embodiment of the present invention.

FIG. 3 is a flowchart that gives a list of attributes of an item and allows the user to edit the list, according to one embodiment of the present invention.

FIG. 4 illustrates attributes of a digital camera along with their values using a sliding bar, according to one embodiment of the present invention.

FIG. 5 illustrates attributes for an airline trip search initiated by a user along with their values using a radio button, according to one embodiment of the present invention.

FIG. 6 is a flowchart that illustrates a way to compute the score, according to one embodiment of the present invention.

FIG. 7 is a flowchart that illustrates the steps when a user changes one or more attributes or the value of one or more attributes, according to one embodiment of the present invention.

FIG. 8 is a flowchart that illustrates the steps taken when a user picks a level of importance for each of the attributes chosen, according to one embodiment of the present invention.

FIG. 9 is a flowchart that illustrates the steps taken to normalize the levels of importance of all the attributes so that the total does not exceed a maximum threshold, according to one embodiment of the present invention.

FIG. 10 illustrates adjustments made by the sort mechanism to FIG. 5 when a maximum threshold is assigned to one or more attributes, according to one embodiment of the present invention.

FIG. 11 is a flowchart that illustrates how data retrieved from a database is stored in a data structure and displayed to a user, according to one embodiment of the present invention.

FIG. 12 is a flowchart that illustrates the sorting of data based on a specific attribute of the item, according to the present invention.

FIG. 13 is a flowchart that illustrates the sorting of data in a particular direction, according to the present invention.

FIG. 14 is a flowchart that illustrates how data is redisplayed to a user when a change occurs, according to the present invention.

FIG. 15 illustrates the results of sorting a list of digital cameras using attribute values (levels of importance), according to one embodiment of the present invention.

FIG. 16 illustrates the results for digital cameras found when the attribute values of FIG. 7 are changed.

FIG. 17 illustrates the results of sorting a list of digital cameras using attribute values (levels of importance), according to one embodiment of the present invention.

FIG. 18 illustrates sorting of the search results of FIG. 9 by clicking on a heading, according to one embodiment of the present invention.

FIG. 19 is an illustration of an embodiment of a computer execution environment.

### DETAILED DESCRIPTION OF THE INVENTION

The embodiments of the present invention are a method to rank selections according to one or more user attributes or criteria and to display the selections to the user. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

Attributes

According to one embodiment, a user interface allows a user to start the search by typing in the class of the item. For example, digital camera, airline ticket, stocks and bonds, etc. After that the search mechanism, according to one embodiment, gives a list of attributes pertaining to the class that the search mechanism assumes to be important to the user. For example, if the user is searching for a digital camera then the mechanism may give a list of attributes comprising price, pixel amount, weight, zoom amount, and amount of memory. On the other hand, if the user is searching for an airline ticket, then the mechanism may give an attribute list comprising price, number of stops, time of departure, and time of arrival.

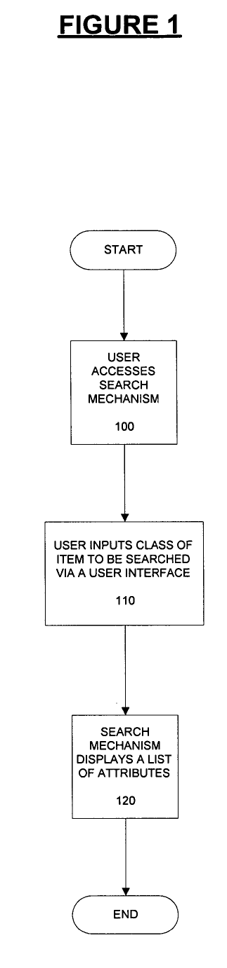

FIG. 1 is a flowchart that illustrates the above embodiment, where at step 100 a user accesses the search mechanism. At step 110, the user inputs via a user interface the class of the item to be searched. At step 120, the search mechanism displays a list of attributes of the class that it presumes to be important in aiding the user with the search.

According to another embodiment, the mechanism gives a general list of attributes, and a user interface whereby the user can pick one or more attributes pertaining to the class. In other words, the user can pick one or more attributes of the class from an almost exhaustive list of attributes, which may or may not correspond to attributes of the class when the list is generated from a general database.

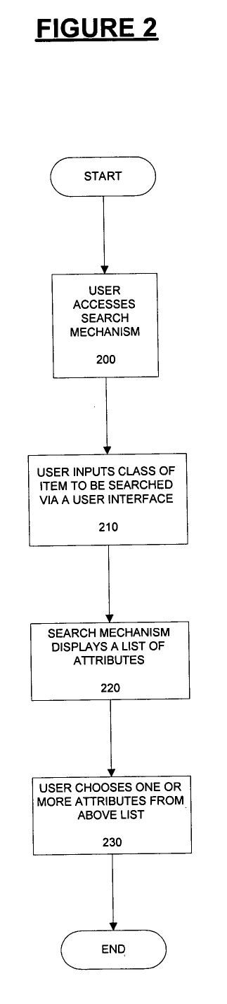

FIG. 2 is a flowchart that illustrates the above embodiment, where at step 200 a user accesses the search mechanism. At step 210, the user inputs via a user interface the class of the item to be searched. At step 220, the search mechanism retrieves a list of attributes from a general database and displays it to the user. At step 230, the user chooses one or more attributes from the list.

According to another embodiment, the mechanism gives a list of attributes pertaining to the class, but also gives the user the option to change the number and types of attributes via a user interface. In other words, the user can delete one or more attributes given by the mechanism or be able to add one or more attributes not mentioned in the list that the user believes to be important in the search process. For example, in the case of searching for a digital camera, the user may want to know if the camera is capable of taking short video clips, or in the case of searching for an airline ticket, the user may want to know the meal options available on the flight, both of which may not be displayed in the list of attributes by the search mechanism.

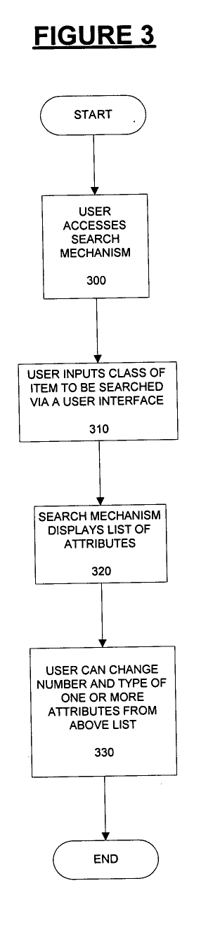

FIG. 3 is a flowchart that illustrates the above embodiment, where at step 300 a user accesses the search mechanism. At step 310, the user inputs the class of the item to be searched via a user interface. At step 320, the search mechanism displays a list of attributes of the class, and at step 330, the user, via a user interface, can change the number and type of attributes that user feels is important in the search process.

Rank

According to another embodiment, after the user finalizes the list of attributes to aid in the search process, the user can pick a level of importance or rank for each of the selected attributes. There is a user interface component that allows the user to pick the rank for the chosen attributes. According to one embodiment, the user interface is a sliding bar next to the title of each attribute. The user can slide a slider within the sliding bar horizontally back and forth from left to right. Conventionally, the leftmost position of the slider is the lowest level of importance, the rightmost position is the highest level of importance, while a position near the mid point is an average level of importance.

For example, in the case of finding a digital camera, the user may have the slider for the price and pixel amount at the rightmost position thus indicating attributes that are very important in the selection process. On the other hand, zoom amount and amount of memory may not be important to the user and the sliders may be in between the leftmost position and the mid point. In the case of searching for an airline ticket, the user may want to leave at a particular time, and will thus have the slider for the time of departure at the rightmost position. The user may not care how many stops the plane makes, and may be marginally concerned about the cost of the ticket and the time of arrival at the destination. In this scenario, the slider for the number of stops will be at the leftmost position, and the sliders for the price and time of arrival will be between the leftmost position and the mid point.

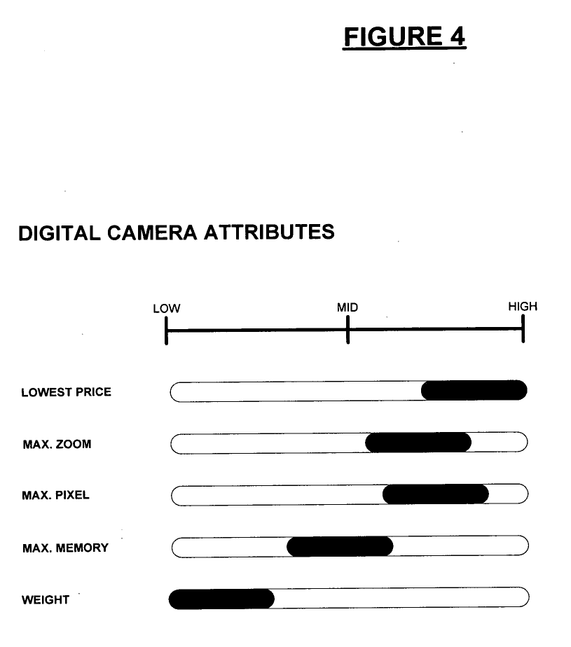

FIG. 4 illustrates 5 attributes of a digital camera along with their ranks using the sliding bar embodiment of the present invention. As can be seen, the camera with a the lowest price is most important to the user (slider is on the rightmost position). Maximum zoom and maximum pixel amounts available at the lowest price are the next most important (sliders for these two attributes are between the mid point and rightmost positions). The user is marginally concerned about the maximum memory capabilities of the camera (slider is near the midpoint position), and user does not have any concerns regarding the weight of the camera, which is indicative by the slider for this attribute being at the leftmost position.

According to another embodiment, the user interface is a series of radio buttons next to each attribute, each with a rank. The ranks can be textual headings such as “very important”, “important”, “not as important”, and “least important”. These ranks can also be percentile amounts, for example, “100%” could correspond to a “very important” rank, “75%” could correspond to an “important” rank, “50%” could correspond to an “average” rank, “25%” could correspond to a “not as important” rank, and “0%” could correspond to a “least important” rank.

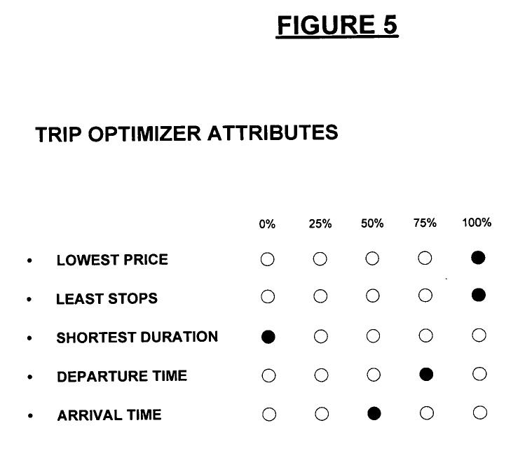

FIG. 5 illustrates the above embodiment for an airline trip search initiated by a user. The Figure has 5 attributes important to the user in aiding the search for an airline ticket, and are lowest price available, least stops, shortest duration, and departure and arrival times. The illustration uses the percentile value for the ranks of each of the attributes as explained above. We can see from FIG. 5 that the most important attributes to the user are the lowest fair and number of stops, followed by departure time. The arrival time and the shortest duration available are marginally and not as important to the user, respectively.

According to another embodiment, the user interface can be a set of knobs each associated with an attribute that a user can rotate. By turning a knob clockwise, a user may increase the rank of an attribute, and by turning the knob anti-clockwise, the user may decrease the rank of the attribute. According to another embodiment, the user interface can be a drop down menu associated with each attribute with such headings as “very important” to “least important” or percentile values such as “100%” to “0%” that the user can highlight and choose for each attribute. Yet another embodiment of an user interface can be a set of “>” and “<” buttons associated with each attribute. By pressing the “>” button, a user can increase the rank of an attribute, and by pressing the “<” button, the user can decrease the rank of the attribute. One skilled in the art will appreciate that the user interface embodiments shown above are for purposes of illustration, and are some of the many possibilities without departing from the scope of the invention.

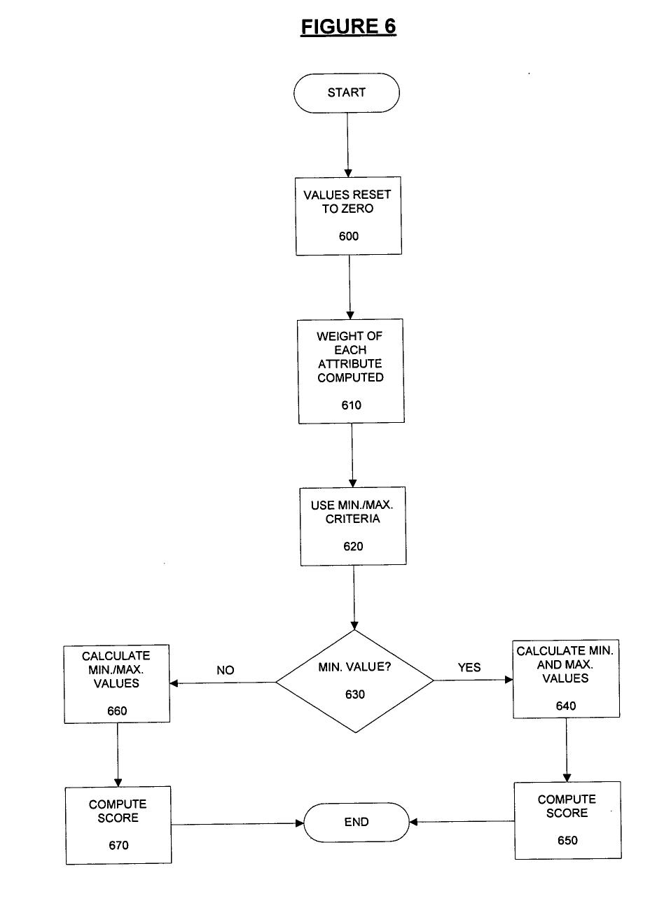

One way to compute the rank is to use the information from data structures used for displaying data to a user (explained under the Display sub-section below). FIG. 6 is a flowchart that illustrates a way to compute the rank of an attribute. At block 600, the ranks are reset to begin from zero. At block 610, the weight of each attribute is computed. One way to compute the rank based on the level of importance of that attribute is to take the minimum or maximum values for each attribute across the board. There may be other criteria to compute the rank based on the level of importance of that attribute which can be used in place of or in addition to the minimum or maximum values. Using the minimum and maximum criteria at block 620, if the rank is based (the “yes” branch from block 630) on a minimum value (block 630), then the minimum and maximum values are computed at block 640. At block 650, the rank for that attribute is computed using the weight computed at block 610 and the minimum and maximum values computed at block 640. If the rank is based on a maximum value (the “no” branch from block 630), then the minimum and maximum values are computed at block 660. At block 670, the rank for that attribute is computed using the weight computed at block 610 and the minimum and maximum values computed at block 660.

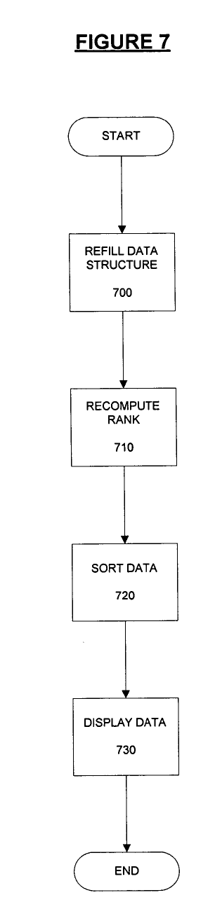

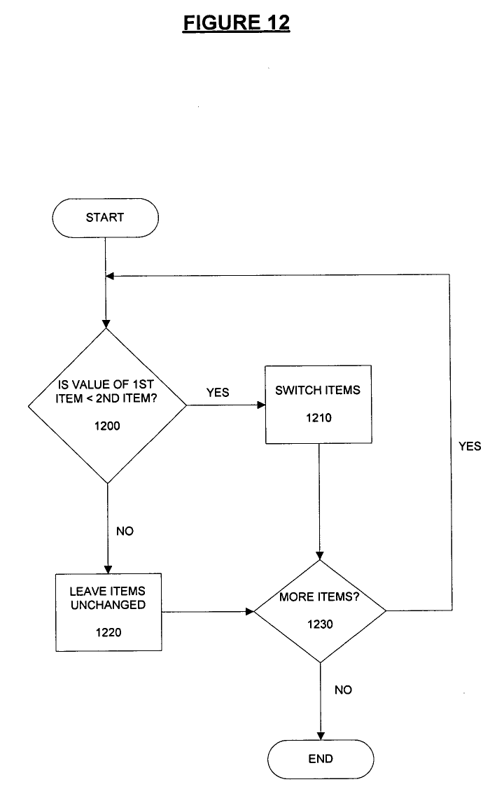

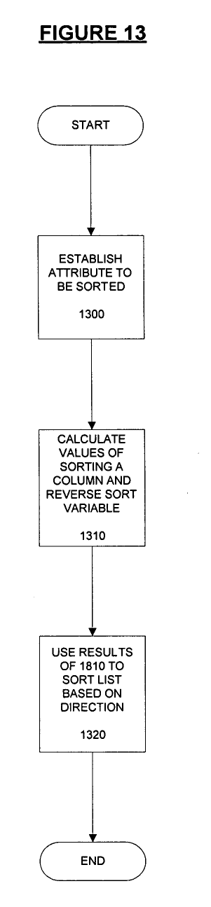

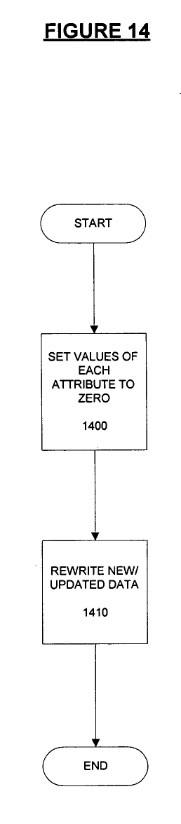

The user may change one or more attributes or the rank of one or more attributes, in which case the entire display has to be changed based on the new criteria. FIG. 7 is a flowchart that illustrates the steps when a user changes one or more attributes or the rank of one or more attributes. At block 700, the data structure used to display data to a user is refilled. At block 710, the rank is recomputed by going through FIG. 6 once. At block 720, the data is sorted by going through FIGS. 12 and 13 (see below) once. Finally, at 730, the display is redone by going through FIG. 14 (see below) once.

Threshold

According to one embodiment, the user can pick the rank (or level of importance) for each of the attributes chosen, but the total or sum of the ranks of all the attributes must be equal to or less than a certain maximum threshold. This limitation is important in view of another embodiment of the present invention that assigns maximum threshold limits to one or more attributes. When these limits are reached and there are more attributes to account for, the search mechanism adjusts (normalizes) the levels of all the attributes accordingly so that the total rank does not exceed the maximum threshold.

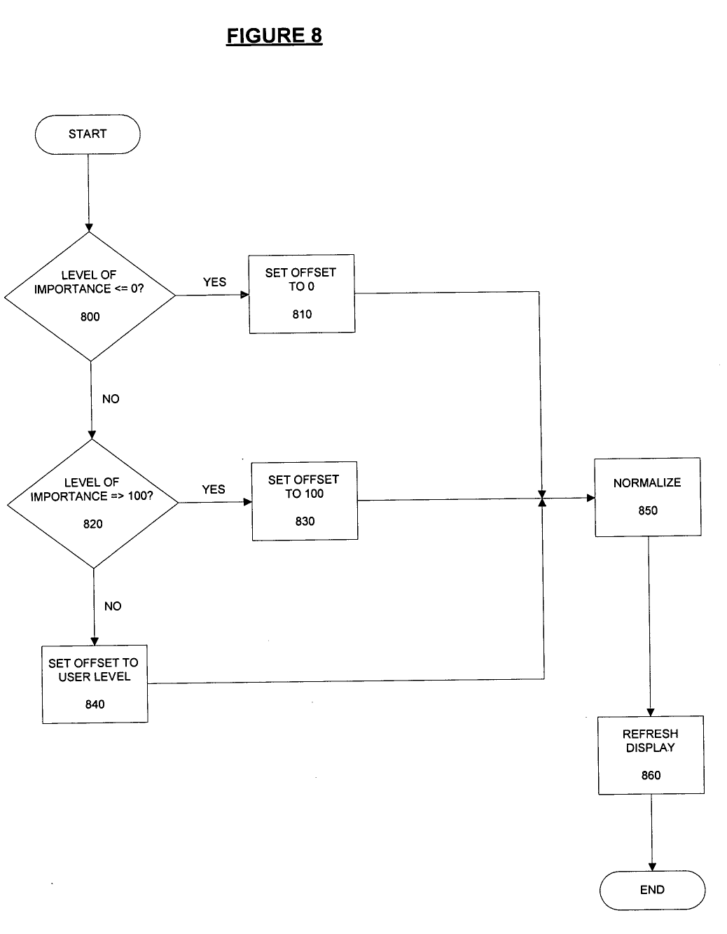

FIG. 8 is a flowchart that illustrates the steps taken when a user picks a level of importance for each of the attributes chosen. The function that performs this task makes sure that the level of importance remains within range (usually the minimum limit is 0, and the maximum limit is 100), and adjusts the level of importance of other attributes when the total rank exceeds some limit. This prevents a user from maxing out the level of importance of all attributes. It also updates the display after an inactivity by the user after a certain predetermined time lapse, for example, 250 milliseconds. At block 800, if the user chooses a level of importance equal to or less than zero, then at block 810 the offset is set to zero. If, on the other hand, the user chooses a level of importance equal to or more than 100 (block 820), then at block 830 the offset is set to 100. If not, then at block 840, the offset is set to the user level of importance. After blocks 810, 830, or 840, the function normalizes all the levels of importance at block 850 so that the total rank does not exceed some maximum threshold. Finally, at block 860, the display is refreshed after a certain predetermined time of inactivity by the user.

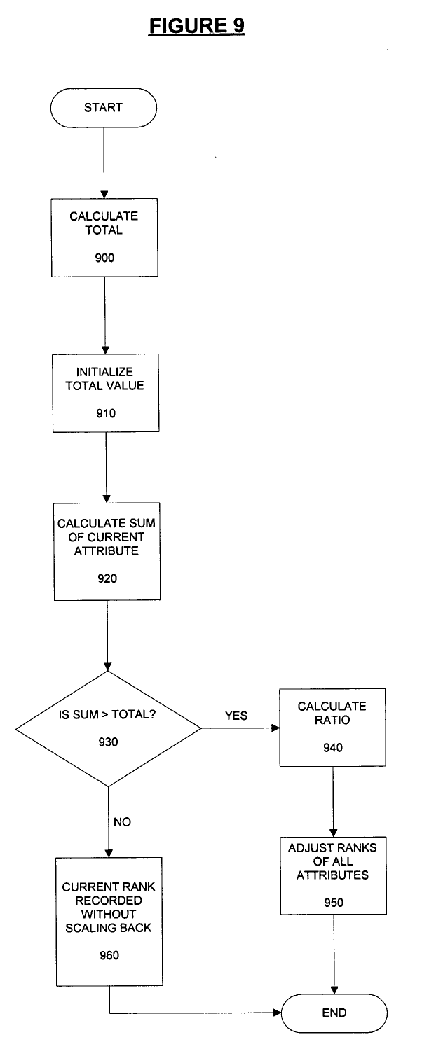

FIG. 9 is a flowchart that illustrates the steps taken to normalize the levels of importance of all the attributes so that the total rank does not exceed a maximum threshold. For example, if the maximum threshold is 200, and two of the attributes are at 100% importance level, the maximum threshold limit has been reached and the levels have to be normalized to stay within the maximum threshold value. The purpose is to prevent a user from maxing out all the attributes and thus expressing no preference. If ranks have to be scaled back, they are done so proportionally to their current value. This scaling back is done by first taking the sum of all the other attribute ranks and adding it to the current rank. If the sum exceeds the maximum threshold, then the ratio of the sum to the remaining limit is calculated before dividing all the attribute ranks by this ratio. At block 900, the total is calculated which is the maximum threshold less the current rank. At block 910, the total value is initialized to zero. At block 920, the sum of the current attribute is calculated. At block 930, if this sum is greater than the total, then at block 940 (the “yes” branch) the ratio is calculated, which is total divided by sum. At block 950, the adjusted ranks of all the attributes is calculated. If the sum at block 930 is not greater than the total (the “no” branch), then at block 960 the current rank is taken without scaling back any of the attribute levels.

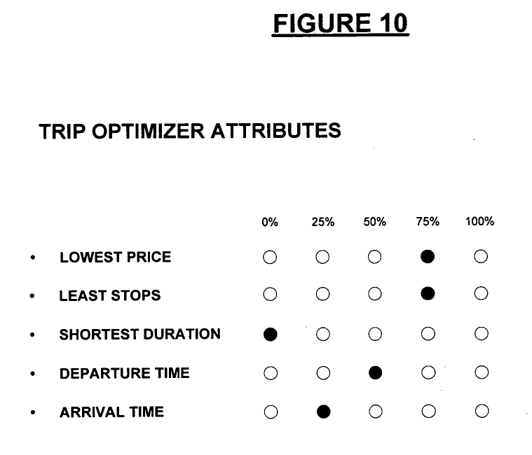

In the search for the airline ticket in FIG. 5 above, if the maximum threshold of 100% is assigned to the first attribute only (lowest price), and the user fills in the rank for the least stops (100%), the search mechanism adjusts the ranks of the two attributes so that the total rank does not exceed the maximum threshold. Since there are 3 more attributes left for the user to fill in, the search mechanism adjusts the rank of each attribute accordingly. FIG. 10 illustrates adjustments made by the search mechanism to FIG. 5 when a maximum threshold is assigned to one or more attributes. As seen, the ranks have changed from what the user initially requested, but the order of the items generated by the search mechanism for both FIGS. 5 and 10 will be the same. That is, if the search mechanism displayed, for example, a list of airlines meeting the criteria of the user in FIG. 5, then that list will be in the same order in FIG. 10 after the normalization process.

Display

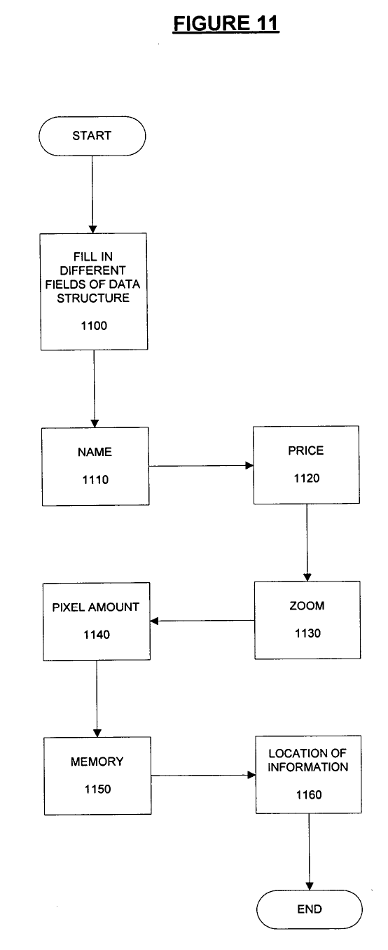

According to another embodiment, the search results displayed to the user comes from a central database source or some other data source such as an aggregation of data on the web. FIG. 11 is a flowchart that illustrates how data retrieved from a database is stored in a data structure. At block 1100, the different fields of the data structure are filled based on the information retrieved from the database. These fields, for a digital camera may include: name of camera (block 1110), price of camera (block 1120), maximum zoom of camera (block 1130), maximum pixel amount of camera (block 1140), maximum memory of camera (block 1150), and the location from where this information is retrieved (block 1160) which usually remains hidden from the user.

The items in the search results can be sorted by a user based on the attributes of the item. Usually the first item in the list (if more than one item is found by the search mechanism) will be the one that is closest to or meets the desired ranks of all the attributes, and the last item will be the one that is furthermost away from the desired ranks of all the attributes. FIG. 12 is a flowchart that illustrates the sorting of the data based on a specific attribute of the item in the search. At block 1200, if the value of the attribute of the first item of the search is less than the attribute value of the second item, then at block 1210 the order of the items are switched, else at block 1220 the order remains unchanged. A check is made at block 1220 to see if there are more items in the search. If there are more items, this comparison is repeated until all the items in the search are compared with the other items.

The items in the search can be sorted based on the value of an attribute, and in a particular direction (ascending or descending order). FIG. 13 is a flowchart that illustrates the sorting of data in a particular direction. At block 1300, the attribute to be sorted is established. This can be accomplished by a user making a mouse click on the heading of the attribute to be used to sort the items. At block 1310, the values of sorting a column and the reverse sort variable are calculated. At block 1320, the results of block 1310 are used to sorted the list based on the direction of the sort. This direction can be alternated between ascending to descending order and vice versa. In other words, the first time a user clicks an attribute heading, the order of the list is usually from a descending to an ascending order of importance of that attribute. When the user clicks the same attribute again, the order is reversed (ascending to descending order of importance of that attribute or back to the usual default order).

Once data has been sorted or updated by a user, or the user changes the level of importance of one or more attributes, the results have to be redisplayed to the user. Also if attribute values change in the database, or more items get added or items get removed from the database while a user is using the system, then the results have to be redisplayed to the user. FIG. 14 is a flowchart that illustrates how data is redisplayed to a user when a change occurs. At block 1400, the values of all the attributes are set to zero. One way of doing this would be to delete the data of all the rows sequentially. At block 1410, the new or updated data is rewritten in all the rows sequentially.

According to another embodiment, the search results are displayed to a user in real time. This means that if the user changes the rank of any attribute, the results refresh corresponding to the current ranks. It also means that if certain attributes or values of attributes constantly change, for example, the cost of a stock, or the wind direction and wind speed in a city, then these values are refreshed in real time too. The user has the option of shutting off the real time update feature of the present invention, especially if the user feels that the items being searched do not change attributes or values of attributes constantly, or the user wants to conserve on computer resources.

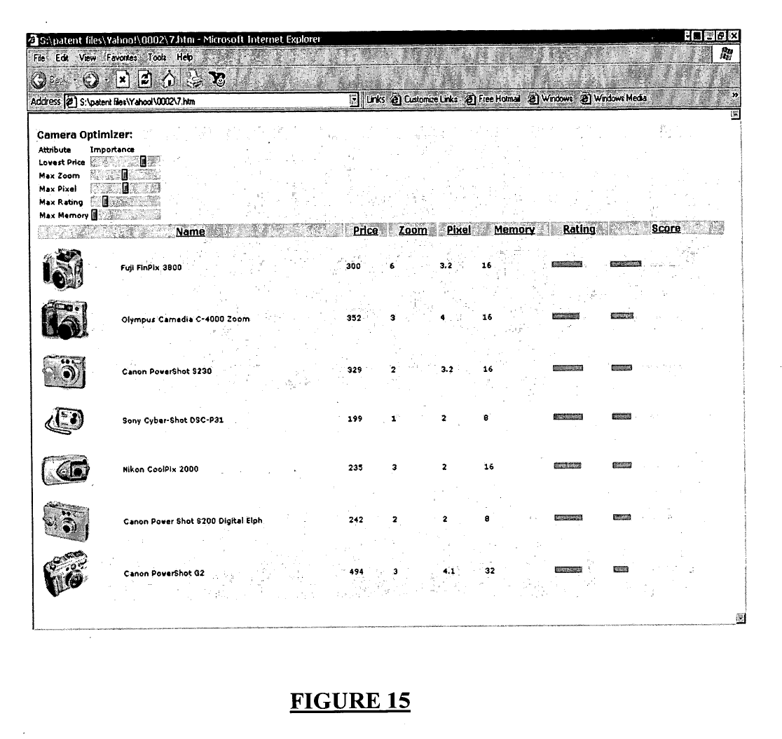

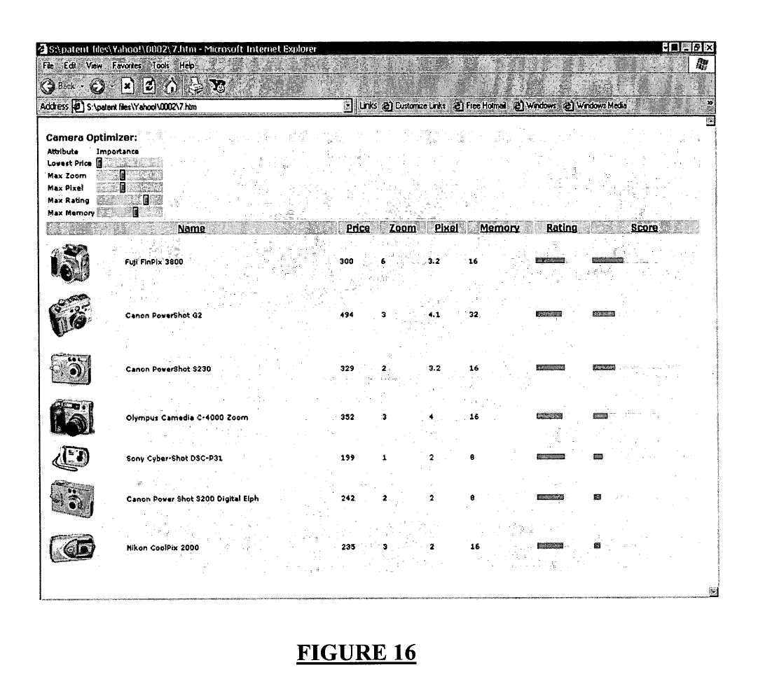

FIG. 15 illustrates the results of searching for a digital camera. There are 5 attributes of the digital camera which are important to the user, namely, lowest price, maximum zoom, maximum pixel, maximum rating, and maximum memory. The ranks for the 5 attributes are as follows: 100% for price, 75% for maximum zoom and pixel, 30% for maximum rating, and 0% for maximum memory. It should be noted here that these values are normalized in the Figure as the maximum threshold has been reached. FIG. 16 illustrates the results for digital cameras found when the above attribute ranks are changed to 0% for price, 50% for maximum zoom and pixel, 100% for maximum rating and 80% for maximum memory. Again these values have been normalized in the Figure. As seen, the order of the results have changed between FIGS. 15 and 16 when the user changes the rank of one or more of the 5 attributes. For example, Canon PowerShot G2® is the last item in FIG. 7, but moves up the list to second place in FIG. 8.

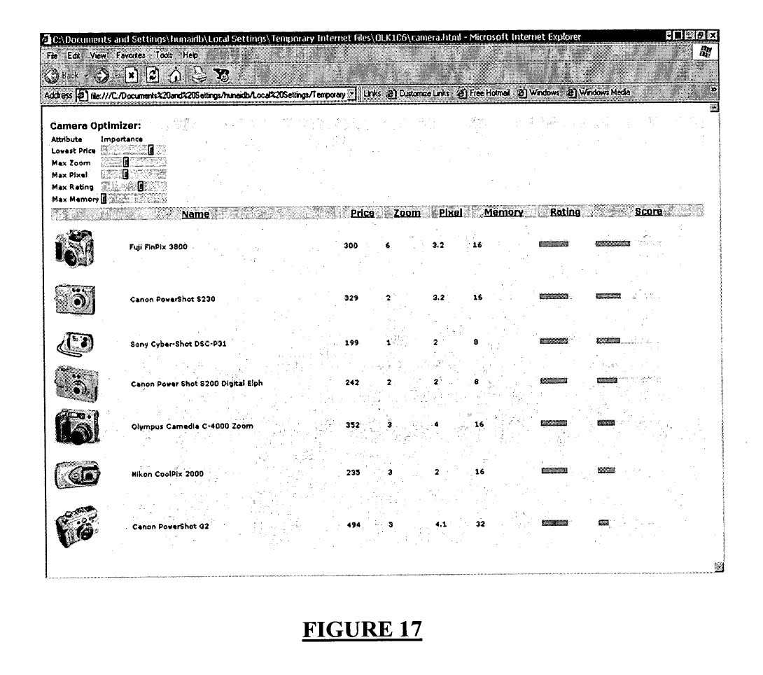

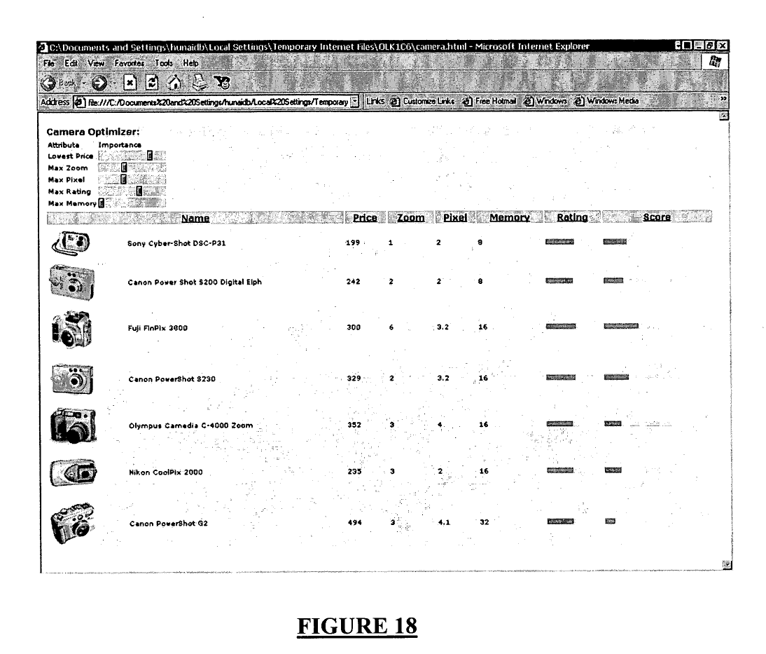

According to another embodiment, the results are displayed as a table with headings corresponding to the attributes chosen by the user. When a heading is clicked, the user makes that attribute as either the most important or the least important attribute, even if initially the user had a different rank for that attribute. As explained above, usually the first item in the list is the one that meets or is closest to the ranks of all the attributes, hence clicking on a heading of a list (usually displayed in descending order) changes the order of the list sorted by the clicked attribute. According to another embodiment, the order of the results in the table can be sorted in real time by clicking on a heading. FIG. 17 illustrates the results of searching for a digital camera. Like FIGS. 15 and 16 above, there are 5 attributes of digital cameras which are important to the user, namely, lowest price, maximum zoom, maximum pixel, maximum rating, and maximum memory. The ranks for the 5 attributes are as follows: 100% for lowest price, 50% for maximum zoom and pixel, 80% for maximum rating, and 0% for maximum memory. Again these values have been normalized in the Figure. The items in the displayed list are in descending order. In other words, the first item in the list (Fuji FinPix 3800®) is the one that is closest to or meets the ranks of all the above attributes. FIG. 18 illustrates the order of the list of FIG. 17 by clicking on the heading “Memory”. As seen, the order of the results have changed between FIGS. 17 and 18 when the user changes the rank of the “Memory” attribute by clicking on its heading in the table. Since minimum memory is now the most important attribute to be considered, coupled with the level of importance of the other attributes, the Sony Cyber-Shot DSC-P31 moves to the top of the list from the third position it held in FIG. 17, and Fuji FinPix 3800® moves to the third position from the final position it held in FIG. 17.

Embodiment of a Computer Execution Environment

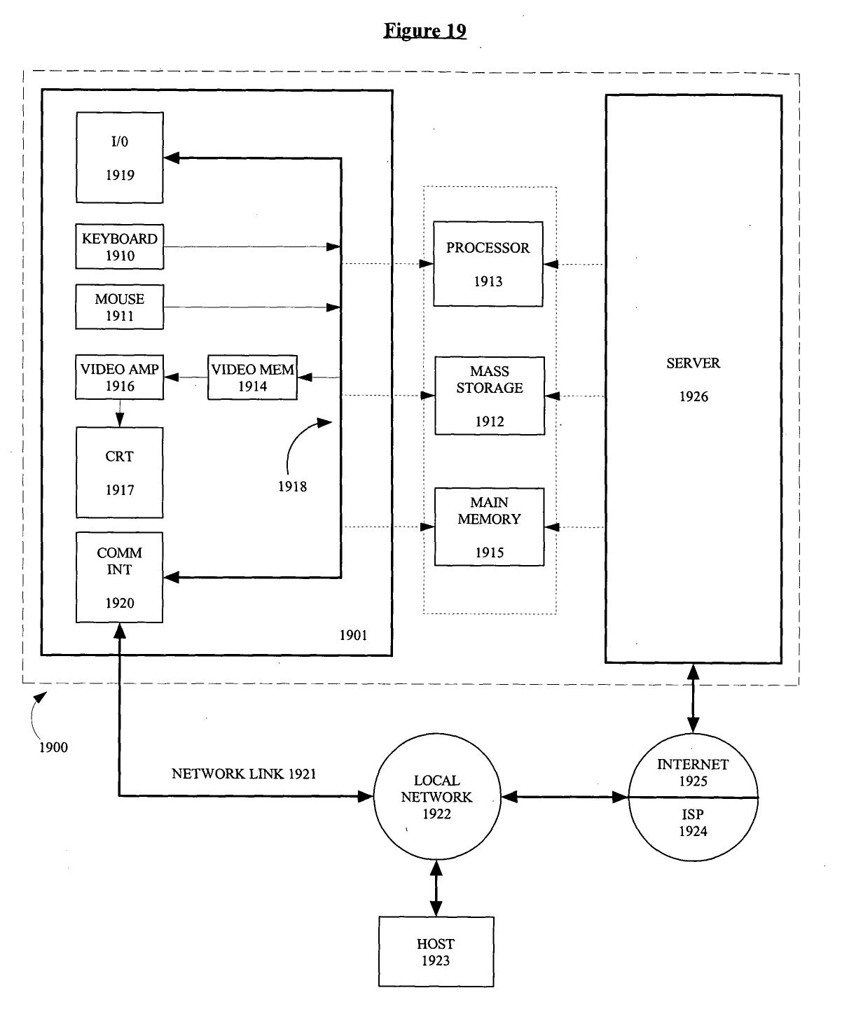

An embodiment of the invention can be implemented as computer software in the form of computer readable code executed in a desktop general purpose computing environment such as environment 1900 illustrated in FIG. 19, or in the form of bytecode class files running in such an environment. A keyboard 1910 and mouse 1911 are coupled to a bi-directional system bus 1918. The keyboard and mouse are for introducing user input to a computer 1901 and communicating that user input to processor 1913.

Computer 1901 may also include a communication interface 1920 coupled to bus 1918. Communication interface 1920 provides a two-way data communication coupling via a network link 1921 to a local network 1922. For example, if communication interface 1920 is an integrated services digital network (ISDN) card or a modem, communication interface 1920 provides a data communication connection to the corresponding type of telephone line, which comprises part of network link 1921. If communication interface 1920 is a local area network (LAN) card, communication interface 1920 provides a data communication connection via network link 1921 to a compatible LAN. Wireless links are also possible. In any such implementation, communication interface 1920 sends and receives electrical, electromagnetic or optical signals, which carry digital data streams representing various types of information.

Network link 1921 typically provides data communication through one or more networks to other data devices. For example, network link 1921 may provide a connection through local network 1922 to local server computer 1923 or to data equipment operated by ISP 1924. ISP 1924 in turn provides data communication services through the world wide packet data communication network now commonly referred to as the “Internet” 1925. Local network 1922 and Internet 1925 both use electrical, electromagnetic or optical signals, which carry digital data streams. The signals through the various networks and the signals on network link 1921 and through communication interface 1920, which carry the digital data to and from computer 1900, are exemplary forms of carrier waves transporting the information.

Processor 1913 may reside wholly on client computer 1901 or wholly on server 1926 or processor 1913 may have its computational power distributed between computer 1901 and server 1926. In the case where processor 1913 resides wholly on server 1926, the results of the computations performed by processor 1913 are transmitted to computer 1901 via Internet 1925, Internet Service Provider (ISP) 1924, local network 1922 and communication interface 1920. In this way, computer 1901 is able to display the results of the computation to a user in the form of output. Other suitable input devices may be used in addition to, or in place of, the mouse 1911 and keyboard 1910. I/O (input/output) unit 1919 coupled to bi-directional system bus 1918 represents such I/O elements as a printer, A/V (audio/video) I/O, etc.

Computer 1901 includes a video memory 1914, main memory 1915 and mass storage 1912, all coupled to bi-directional system bus 1918 along with keyboard 1910, mouse 1911 and processor 1913.

As with processor 1913, in various computing environments, main memory 1915 and mass storage 1912, can reside wholly on server 1926 or computer 1901, or they may be distributed between the two. Examples of systems where processor 1913, main memory 1915, and mass storage 1912 are distributed between computer 1901 and server 1926 include the thin-client computing architecture developed by Sun Microsystems, Inc., the palm pilot computing device, Internet ready cellular phones, and other Internet computing devices.

The mass storage 1912 may include both fixed and removable media, such as magnetic, optical or magnetic optical storage systems or any other available mass storage technology. Bus 1918 may contain, for example, thirty-two address lines for addressing video memory 1914 or main memory 1915. The system bus 1918 also includes, for example, a 32-bit data bus for transferring data between and among the components, such as processor 1913, main memory 1915, video memory 1914, and mass storage 1912. Alternatively, multiplex data/address lines may be used instead of separate data and address lines.

In one embodiment of the invention, the processor 1913 is a microprocessor manufactured by Motorola, such as the 680x0 processor or a microprocessor manufactured by Intel, such as the 80x86 or Pentium processor, or a SPARC microprocessor from Sun Microsystems, Inc. However, any other suitable microprocessor or microcomputer may be utilized. Main memory 1915 is comprised of dynamic random access memory (DRAM). Video memory 1914 is a dual-ported video random access memory. One port of the video memory 1914 is coupled to video amplifier 1916. The video amplifier 1916 is used to drive the cathode ray tube (CRT) raster monitor 1917. Video amplifier 1916 is well known in the art and may be implemented by any suitable apparatus. This circuitry converts pixel data stored in video memory 1914 to a raster signal suitable for use by monitor 1917. Monitor 1917 is a type of monitor suitable for displaying graphic images.

Computer 1901 can send messages and receive data, including program code, through the network(s), network link 1921, and communication interface 1920. In the Internet example, remote server computer 1926 might transmit a requested code for an application program through Internet 1925, ISP 1924, local network 1922 and communication interface 1920. The received code may be executed by processor 1913 as it is received, and/or stored in mass storage 1912, or other non-volatile storage for later execution. In this manner, computer 1900 may obtain application code in the form of a carrier wave. Alternatively, remote server computer 1926 may execute applications using processor 1913, and utilize mass storage 1912, and/or video memory 1915. The results of the execution at server 1926 are then transmitted through Internet 1925, ISP 1924, local network 1922, and communication interface 1920. In this example, computer 1901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method to display the results of searching for an item to a user is described in conjunction with one or more specific embodiments.

I claim:

1. A method for ranking a user's preference to search a class constituting one or more items comprising:
submitting said class by said user to a search mechanism;
submitting a plurality of attributes of said class by said search mechanism to said user;
choosing one or more attributes from said plurality of attributes by said user;
submitting a rank for each of said one or more attributes by said user to said search mechanism; and
displaying one or more items from said class along with a value of said one or more attributes for each of said items by said search mechanism to said user.

2. The method of claim 1 wherein said plurality of attributes of said class submitted by said search mechanism to said user is a non-editable list.

3. The method of claim 1 wherein said plurality of attributes of said class submitted by said search mechanism to said user is an editable list wherein said user can add or delete one or more of said attributes.

4. The method of claim 1 wherein said plurality of attributes submitted by said search mechanism to said user has a maximum threshold set on one or more of said plurality of attributes such that a total rank of said one or more attributes submitted by said user to said search mechanism does not exceed said maximum threshold.

5. The method of claim 4 further comprising:
normalizing said rank of one or more attributes when said maximum threshold is reached.

6. The method of claim 5 further comprising:
calculating a total value which is a difference between said maximum threshold and a current rank of an attribute;
calculating sum of said attribute;
calculating a ratio which is said total rank divided by said sum if said sum is greater than said total rank; and
calculating adjusted ranks of each of said one or more attributes if said sum is greater than said total rank.

7. The method of claim 1 wherein said rank of each of said one or more attributes is submitted by said user to said search mechanism via a plurality of radio buttons.

8. The method of claim 1 wherein said rank of each of said one or more attributes is submitted by said user to said search mechanism via a slider within a sliding bar.

9. The method of claim 1 wherein said one or more items displayed to said user is displayed as a table with one or more headings corresponding to said one or more attributes sent by said user to said search mechanism.

10. The method of claim 9 wherein said one or more items displayed to said user is generated from data obtained from a central database source.

11. The method of claim 9 wherein said one or more items displayed to said user is generated from data obtained from an aggregation of said items on the Internet.

12. The method of claims 10 or 11 further comprising:
storing said generated items in a data structure by filling in a plurality of fields in said data structure.

13. The method of claim 12 wherein one or more of said plurality of fields correspond to one or more of said attributes submitted by said user to said search mechanism.

14. The method of claim 1 wherein said value of said one or more attributes for each of said items is computed using information from said data structure.

15. The method of claim 1 wherein said user can change said rank of said one or more attributes after said items are displayed to said user changing the order of one or more of said displayed items.

16. The method of claim 15 wherein said changing of rank further comprising: clicking on an attribute heading.

17. The method of claim 15 wherein said changing of rank further comprising: submitting a new rank of one or more attributes via said plurality of radio buttons.

18. The method of claim 15 wherein said changing of rank further comprising: submitting a new rank of one or more attributes via said slider within a sliding bar.

19. The method of claim 1 wherein value of said one or more attributes for each of said items can be updated in real time changing the order of one or more of said displayed items.
